(19) United States
(12) Patent Application Publication
(10) Pub. No.: US 2021/0068380 A1
(43) Pub. Date: Mar. 11, 2021

(54) Tunicate Tending and Harvesting System and Method

(71) Applicant: Hans Gude Gudesen, Gamle Fredrikstad (NO)

(72) Inventor: Hans Gude Gudesen, Gamle Fredrikstad (NO)

(21) Appl. No.: 16/644,212

(22) PCT Filed: Aug. 23, 2018
(86) PCT No.: PCT/NO2018/050217

§ 371 Date: Mar. 4, 2020

(30) Foreign Application Priority Data
Sep. 4, 2017 (NO) 20171427

(51) Int. Cl. A01K 80/00; A01K 61/54; A01K 61/60

(52) U.S. Cl. CPC A01K 80/00; A01K 61/60; A01K 61/54

(57) ABSTRACT

A tunicate tending and harvesting system for the tending and harvesting of tunicates (15) grown on at least one elongated, suspended growth surface (7) is disclosed. The system comprises a tending and harvesting machine (14), the machine (14) comprising at least a first and a second treatment stage, and means for moving the at least one growth surface (7) sequentially through the treatment stages. Further, a tunicate tending and harvesting method for the tending and harvesting of tunicates grown on at least one elongated suspended growth surface (7) is disclosed.

### FIELD OF THE INVENTION

The present invention relates to an infrastructure for the farming and harvesting of aquatic organisms attached to surfaces, in particular tunicates. More specifically the invention relates to a tunicate tending and harvesting system for the tending and harvesting of tunicates grown on elongated, suspended growth surface, and a method for the same.

### BACKGROUND OF THE INVENTION

Floating bioproduction facilities for marine sessile organisms are found all over the world, in the form of suspended growth substrates for mussels, oysters, kelp, etc. Recently, considerable interest has focused on tunicates, which exhibit very high productivity and can provide valuable biomass as food for fish and animals as well as special cellulose for industry. The tunicates are farmed on surfaces suspended in the ocean, typically nets, cables or elongated sheets, and harvesting is performed by traditional methods involving a large degree of human intervention and manual labor. Despite their obvious potential, tunicates have not been exploited in large scale farming operations until now. The main reason for this is the lack of infrastructure and methods that enable highly automated tending and harvesting of tunicates on an industrial scale.

Tunicates are marine invertebrate animals belonging to the subphylum Tunicata. They are marine filter feeders with a water-filled, sac-like body structure and two tubular openings through which they draw in and expel water. Most adult tunicates are sessile and are permanently attached to rocks or other hard surfaces on the ocean floor. By far the largest class of tunicates is the Ascidians, also commonly known as sea squirts. Among the ascidians, the species Ciona intestinalis is of particular interest in the present context. The body of an ascidian is surrounded by a tunic which varies in thickness between species but may be tough, resembling cartilage, thin and delicate, or transparent and gelatinous. The tunic is composed of proteins and complex carbohydrates, and includes tunicin, a variety of cellulose. Inside the tunic is the body wall or mantle composed of connective tissue, muscle fibers, blood vessels and nerves. A large pharynx occupies most of the interior of the body. It is a muscular tube linking the buccal opening with the rest of the gut. It has a ciliated groove which secretes a mucous net that collects food particles. The walls of the pharynx are perforated by several bands of slits through which water escapes into the surrounding water-filled cavity. The latter is criss-crossed by various rope-like mesenteries which provide support for the pharynx and also hold up the other organs.

The interest in tunicates is due to several factors:
Tests have shown that their interior biomass can provide superior raw material for animal and fish feed, as well as for fertilizers. In addition, the tunic can be processed to provide pure cellulose of exceptional fiber length and crystallinity. Consequently, in a harvesting operation it is desirable to ensure optimal recovery of the whole animal, ideally in a single process where removal of the tunicate from the growth surface is combined with an initial separation of the interior body parts from the surrounding tunic.
Tunicates are indigenous to most marine environments in the world (e.g. for Ciona intestinalis: Greenland, Davis Strait, eastern Canada, U.S. (New England, California), Brazil (Rio de Janeiro, Sao Paulo), Chile (Strait of Magellan), Svalbard Islands, Iceland, Faroe Islands, Norway, Sweden, Denmark, Netherlands, Scotland, UK, Spain, Morocco, Cape Verde, Senegal, Angola, South Africa).
Given a minimum of salinity (typically above 16-22 o/oo) they are adaptible to very diverse environments and colonize submerged surfaces in copious numbers and at high density (e.g. 10.000 individuals per m²), representing some of the most productive sources of biomass in the sea.
Being filter feeders, tunicates scavenge food from the surrounding water volume and thus have access to virtually unlimited amounts of nutrients. At the same time, the tunicates remove particulates from the water and act as filtering and cleaning agents.

The Chinese patent application CN 206294749 U «Real ascidian harvester» relates to a harvester for tunicates where the farmed tunicates are being peeled off in a one-step process through a scraping mechanism.

The PCT patent application WO 2016166018 A1 «System and apparatus for cultivating and harvesting aquatic biomass» relates to harvesting of biomass including tunicates, in a system comprising scraping arms and a cleaning device.

The US patent application US 2011217764 A1 «Rotating bioreactor and spool harvester apparatus for biomass production» relates to farming and harvesting of micro algae where a substrate i spooled through a scraper for harvesting of the algae.

The PCT patent application WO 0193671 A «Device for harvesting of and tending to shells and for cleaning of an associated shell collector in water» describes a system for tending and harvesting of shell farmed on elongated net in the sea. The system comprises rolls, cleaning and harvesting devices, and autonomous unit moving along the farm.

The Japanese patent application JP H0799854 A relates to a harvesting device for nets with farmed seaweed, where the net is being gathered on a reel, and the seaweed is cut.

The two Korean patent applications KR 20100010831 U «Rope with twisted thread for sea squirt threshing machine» and KR 20030006085 A “Auto separation machine for sea squirts” describe systems mainly similar to the one described in CN 206294749 U mentioned above.

### Objects of the Present Invention

A main object of the present invention is to provide infrastructure and method that enable highly automated farming of tunicates on an industrial scale.

### SUMMARY OF THE INVENTION

An aspect of the invention is a tunicate tending and harvesting system for the tending and harvesting of tunicates grown on at least one elongated, suspended growth surface, where the system comprises a tending and harvesting machine. The machine comprising at least a first and a second treatment stage, and means for moving the at least one growth surface sequentially through the treatment stages.

The first treatment stage comprising squeezing means arranged to squeeze out soft inner part of the tunicates on the at least one growth surface, and first stage collection means arranged to collect the squeezed out parts. The second treatment stage comprises removal means for removing parts of the tunicates remaining after the first stage, and second stage collection means arranged to collect the removed parts.

Optionally, the squeezing means comprises two mainly cylindrical rollers arranged to squeeze the tunicates when the growth surface passes there between, and optionally, the removal means are arranged for scraping off parts of the tunicates remaining after the first stage, and comprises at least one of the following: a scraping edge and brush.

The machine can further comprise a third treatment stage comprising cleaning means for cleaning the growth surface after the second stage, where the cleaning means comprises at least one of the following: a brush roller and a high pressure liquid or gas jet. Further, the third treatment stage can comprise third stage collection means arranged to collect cleaned off parts of the tunicates.

Optionally, the system comprises disinfection equipment arranged to disinfect the growth surface.

The first treatment stage can comprise a residual removal means arranged to remove residuals remaining on the squeezing means, and residual collection means arranged to collect the removed residuals. The residual removal means can comprise a brush roller.

The means for moving the growth surface can comprise at least one of the following: a take up reel arranged to collect and feed out the growth surface after/before passing the treatment stages, and squeezing means comprising motorized rollers arranged for contributing to the moving.

Optionally, the system comprises threading means comprising a pre-threaded ribbon extending through the treatment stages to the take up reel, arranged to be coupled end-to-end to the growth surface, and to pull the growth surface through the treatment stages and onto the take up reel. The threading means can comprise a re-deployment means arranged to reverse the direction of travel of the growth surface and pre-threaded ribbon.

Further, the system can comprise means for sensing the passage of a junction mechanism joining the growth surface and the pre-threaded ribbon and/or hard objects such as clams and rocks adhering to the growth surface during the passage through the tending and harvesting machine, and for automatic retraction of at least one of the following: the roller, the brush and the scraping edge in response to signals from the sensing means to avoid hitching and entanglement.

The tending and harvesting system can further a positioning subsystem arranged for positioning the tending and harvesting machine for connection/access to the at least one elongated, suspended growth surface. The positioning subsystem can comprise a rig arranged for carrying the machine, rig positioning means for positioning the rig in proximity of the at least one growth surface; and machine positioning means arranged for positioning the machine at locations on the rig allowing the machine to access the growth surface. Further, the positioning subsystem can comprise communication and control means arranged to receive information of a task to be performed related to at least one production module comprising the at least one growth surface, and an identity (address) of the at least one production module, the rig positioning means adapted to be guided by at least one of the following arranged on the production module: beacons, sensors, camera-readable tags, and geometric cues linked to the production modules.

The can rig comprises its own buoyancy means and mobility means for carrying and navigating the machine on water, optionally, the buoyancy means comprises at least two pontoons arranged with a distance in between adapted to straddle productions modules where the growth surface is arranged, and where the rig further comprises a frame with an opening allowing access for the machine to the growth surface. Further, the rig positioning means can comprise a floor or rail system arranged on top of a number of production modules.

Another aspect of the invention is a tunicate tending and harvesting method for the tending and harvesting of tunicates grown on at least one elongated suspended growth surface, where the method comprises the following steps: moving the growth surface sequentially through treatment stages, in a first treatment stage, squeezing out soft inner part of the tunicates on the growth surface, and collecting the squeezed out parts, and, in a second stage, removing parts of the tunicates remaining after the first stage, and collecting the removed parts.

Optionally, the step of removing parts comprises scraping with a scraping edge or a brush.

Optionally, the method comprises the following steps: in a third treatment stage, cleaning the growth surface after the second stage, where the step of cleaning comprises at least one of the following: brushing by a brush roller and using a high pressure liquid or gas jet.

Further, the method can comprise the following steps: positioning the tending and the harvesting machine, coupling the machine to the growth surface, threading the growth surface into the machine, tending and harvesting the growth surface, and redeploying the growth surface.

### SHORT DESCRIPTION OF THE FIGURES

Embodiments of the present invention will now be described, by way of example only, with reference to the following diagrams wherein:

FIGS. 1a, b disclose two versions of a production module.

FIG. 2 discloses a deployed production module.

FIGS. 3 a,b,c,d,e disclose a growth and harvesting cycle in a production module.

FIGS. 4 a,b disclose a generic tending/harvesting machine during the harvesting cycle.

FIGS. 5 a,b,c,d disclose threading of a growth surface into a tending/harvesting machine.

FIG. 6 discloses a triangular cluster of 15 production modules.

FIG. 7 discloses a circular cluster of 7 production modules.

FIGS. 8 a,b disclose clusters of production modules in linear arrangements.

FIGS. 9 a,b,c disclose a harvester in action.

### LIST OF REFERENCE NUMBERS IN FIGS

(1) Upper part annulus
(2) Lower part annulus
(3) Fixture
(4) Fixture
(5) Fixture
(6) Fixture
(7) Growth surface
(8) Cable
(9) Attachment gear
(10) Production module
(11) Rollers
(12) Textured surface
(13) Collection means/Tray
(14) Tending/harvesting machine
(15) Tunicates
(16) Removal means/Scraping edge
(17) Collection means/Tray
(18) Cleaning station
(19) Cleaning means/Brush rollers
(20) Gas/water jets
(21) Take-up reel
(22) Brush roller
(23) Tray
(24) Dummy ribbon
(25) Treatment stage
(26) Opening
(27) Coupling device
(28) Mating feature
(29) Junction mechanism
(30) Upper frame
(31) Lower frame
(32) Connecting linkage
(33) Frame
(34) Pontoon
(35) Chain
(36) Harvester

### DESCRIPTION OF PREFERRED EMBODIMENTS OF THE INVENTION

Various aspects of the disclosure are described more fully hereinafter with reference to the accompanying drawings.

An accumulating body of experience indicates that commercially viable farming of tunicates on a large scale must be based on a physical infrastructure and operative procedures that are highly integrated and require a minimum of human intervention. This is achieved according to the present invention by means of a tending and harvesting system. The system can comprise one or more of the parts presented below, and typically also has operational characteristics as outlined.

Production Modules

The tunicates grow on surfaces suspended in the water, in a floating bioproduction facility centered around production modules (10) where each is adapted to be arranged within a vertical column with a pre-defined horizontal cross section and extending downwards from the water surface. Each production module (10) typically comprises a buoyant upper part (1) at the water surface and a submerged lower part (2) of comparable size and shape at the bottom of the water column. Within this water column, there are disposed growth surfaces, typically in the form of elongated sheets, ribbons, meshes or nets, or alternatively in the form of ropes or cables. The growth surfaces are specifically adapted to accommodate sessile organisms such as tunicates which attach permanently to the growth surface (7) early in their life cycles and grow from nutrients picked up from the surrounding water, which may either be open volumes in natural bodies of water or enclosed volumes in tanks or other enclosures. The growth surfaces (7) have a width less than the opening in the upper part (1) and a length of up to several tens of meters, which allows individual growth surfaces (7) of virtually any length to be deployed and withdrawn from above without disturbing neighboring production modules (10).

In certain cases, the growth surfaces may be suspended freely from the upper part (1), being kept extended by weights. This shall often be less than optimal, due in part to the cumulative burden on the flotation part of the facility, and specifically due to the danger of entanglement in facilities with a dense distribution of growth surfaces (7). A preferred approach is where growth surfaces (7) are suspended between a mounting fixture on the upper part (1) and an anchoring device on the lower part (2), cf. descriptions of preferred embodiments below.

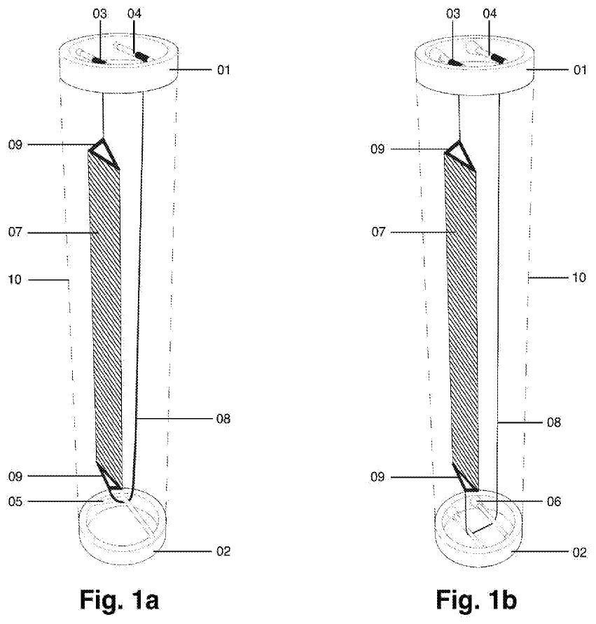

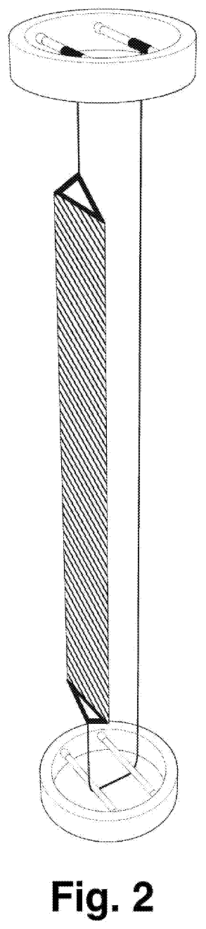

Mounting fixtures, suspension components (i.e. fixture and suspension means) and growth surfaces (7) may take many forms. In order to facilitate understanding of the operational description to follow, two variants of production modules (10) with growth surfaces (7) according to preferred embodiments shall now be described in more detail with reference to FIGS. 1a,b: The upper and lower parts (1, 2) are in the form of annuli (1), (2), each provided with fixtures (3), (4), (5), (6) for the attachment, deployment, manipulation and recovery of growth surfaces (7) and associated suspension components and devices that are positioned between the upper and lower parts (1, 2). A growth surface (7) is shown in the form of a longitudinal flat sheet (7) stretched between the fixtures on the upper and lower parts (1, 2) by means of a set of cables (8) and attachment gear (9). The cables are used for deploying and retrieving the growth surfaces (7) through the opening in the upper part (1), and during the growth cycle they keep the growth surface (7) in position within the volume occupied by the production module (10), indicated by the stippled lines (10) in FIGS. 1a,b.

Spanning the annular upper part (1) is a first mounting fixture (3) from which the growth surface (7) is suspended via a cable (not visible in the figures) and attachment gear (9). The growth surface (7) is connected at the lower end to a cable (8) which passes via a retaining fixture (5), (6) on the submerged lower part (2) and returns to a take-up fixture (4) on the upper part (1). Being located at water depths that may reach 20-50 m. and more, the retaining fixtures (5), (6) must be fail safe, and two simple designs are illustrated in FIGS. 1a,b: In FIG. 1a, the retaining fixture is a shaped crossbar (5) which the cable (8) loops around as shown. In FIG. 1b, the cable is guided across rollers (6). Other possible retaining fixtures shall be, e.g. a smooth tube or chute. In many marine environments, strategies must be adopted to tackle perturbations in the form of wave and tide motion. This may involve transient partial buckling of growth surfaces (7) and active take-up of slack in the mounting fixtures at the upper part and/or at the bottom part. Many mounting variants are possible within the basic suspension mode shown in FIGS. 1a,b. For clarity, a single production module (10) similar to the one shown in FIG. 1b is shown in FIG. 2, without reference numbering.

Tending and harvesting machine Each production module (10) can be identified by a unique address which describes its location. When a production module (10) at a specific address is to be tended or harvested, a command is transmitted to the tending and harvesting machine (14) which responds by moving into position above the production module (10) in question and carrying out a sequence of actions consistent with the command. These actions may be of different kinds, such as monitoring the physical state of the facility or assessing the growth or maturity of the biomass on the growth surfaces (7), or they may be part of the basic farming cycle that includes deployment of growth surfaces (7) and harvesting of biomass.

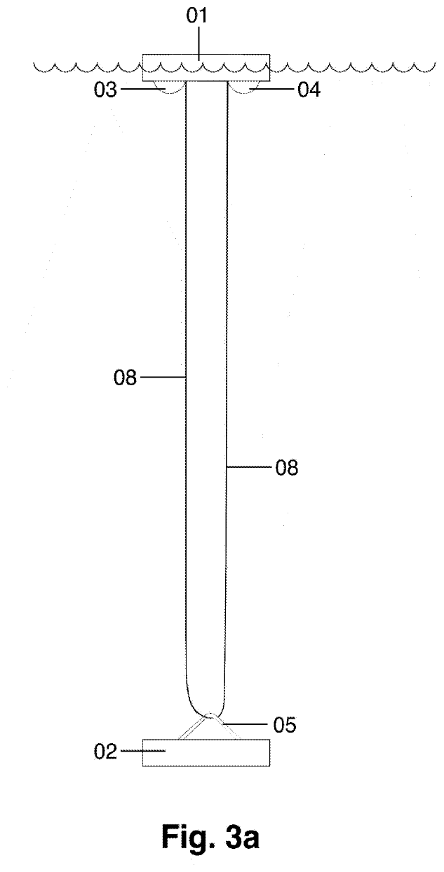

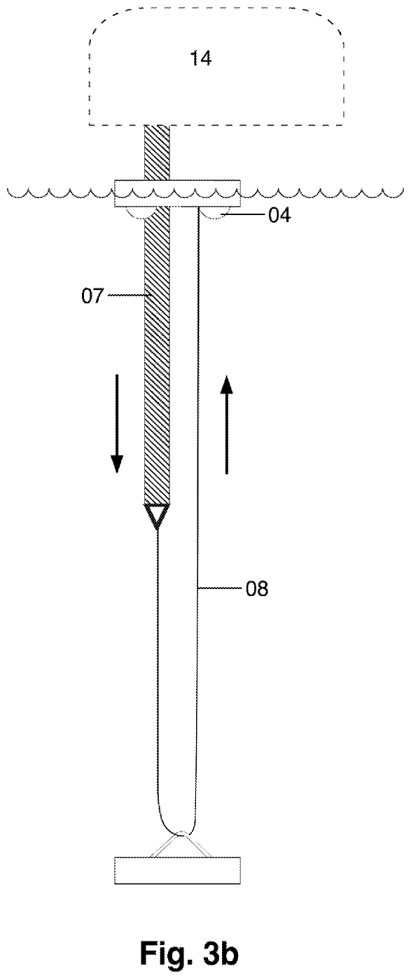

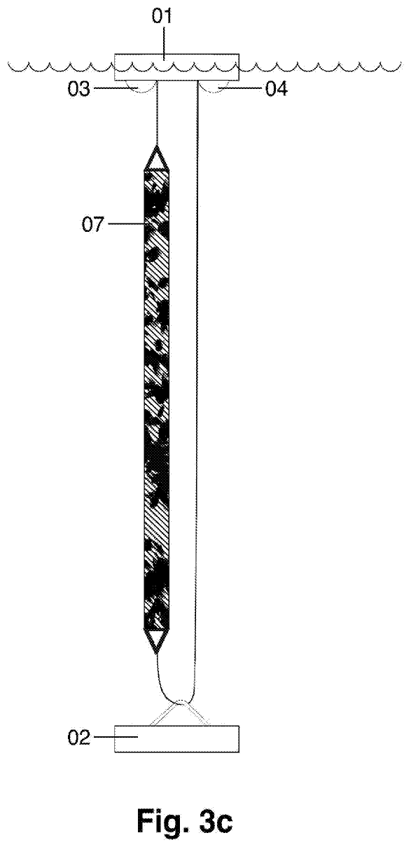

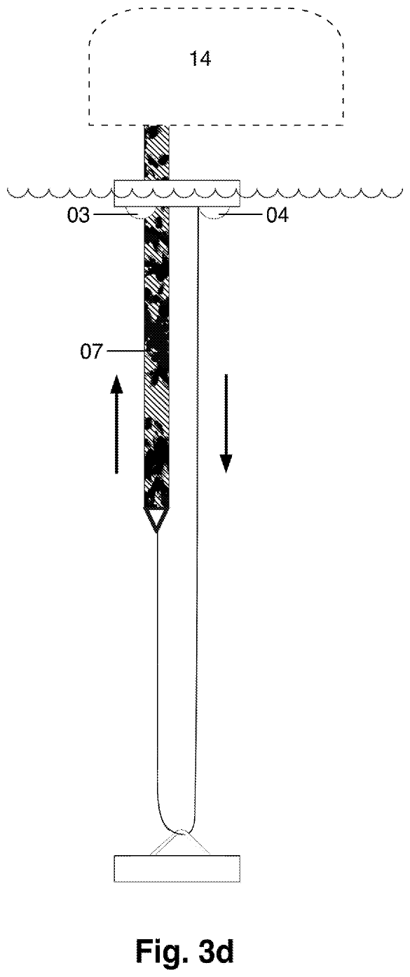

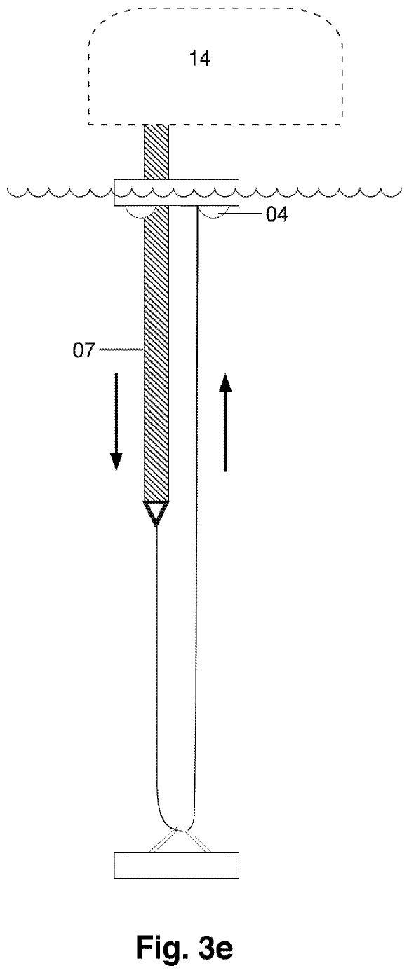

A complete growth and harvesting cycle for sessile organisms which settle naturally from the surrounding water volume shall typically proceed as illustrated in FIGS. 3 a-e: FIG. 3a shows a production module (10) similar to that shown in FIG. 1a in readiness before the cycle is initiated: A cable (8) passes from the mounting fixture (3) on the upper part (1) and down to the retaining fixture (5) on the lower part (2) where it loops back to the take-up fixture (4). In FIG. 3b the cable (8) has been connected to the bottom end of a growth substrate (7) which is being fed down into the water from a tending/harvesting machine (14) while the cable is pulled up at the take-up fixture (4). FIG. 3c shows the normal growth situation where the growth surface (7) is extended between the upper and lower parts (1), (2), being kept suitably taut and in position by the mounting and take-up fixtures (3), (4). FIG. 3d shows the situation in the harvesting phase: The growth surface (7) has been released from the mounting fixture (3) and is drawn out of the water and into the tending and harvesting machine (14), while the cable is being paid out by the take-up fixture (4). The tending/harvesting machine (14) clears the biomass from the substrate and cleans it.

In FIG. 3e the growth surface (7) is returned down into the water, assisted by coordinated pulling on the cable at the take-up fixture (4). Once in place as illustrated in FIG. 3c, a new growth cycle can begin. As an alternative to using cleaned substrates that are seeded opportunistically by larvae in the water volume surrounding the production module (10), it is also possible to incubate the growth surface (7) in a separate controlled environment, before being returned into the production module (10) as shown in FIG. 3e.

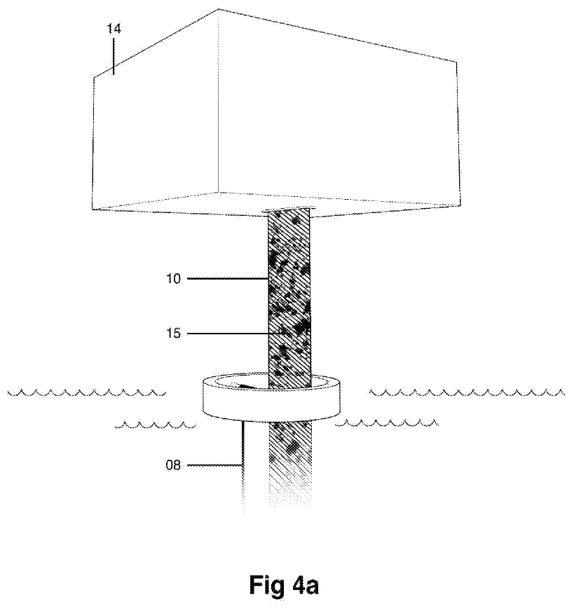

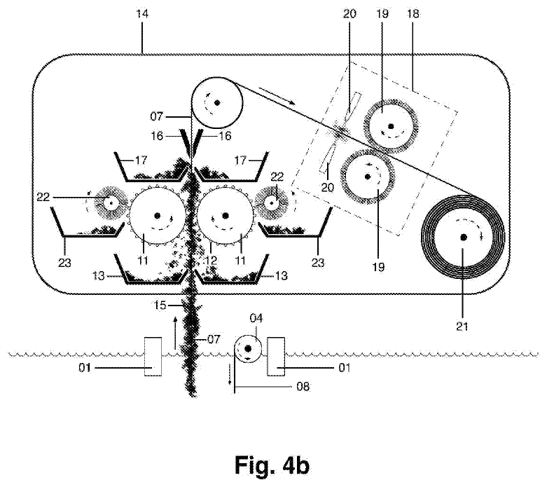

It is important that the tending and harvesting cycle described in generic terms above shall be carried out smoothly and reliably and with a minimum of human intervention. According to the present invention, this is made possible by an integrated system where a tending/harvesting machine (14) constitutes a core component, with technical features as shall now be described with reference to FIGS. 4a,b:

FIGS. 4a,b illustrate an example where harvesting is in progress, having reached a process stage corresponding to that shown in FIG. 3d: The tending/harvesting machine (14) is in position above the production module (10) to be harvested, of which the annular upper part (1) is visible. The growth surface (7), in this case a flat ribbon (7) shown in side view in FIG. 4b, is covered densely by tunicates (15) as it is drawn out of the water and into the machine (14) after having been released from the production module (10). As the growth surface (7) is transferred from the production module (10) to the machine (14), it is kept under tension by means of the take-up fixture (4) which pays out the cable (8) at a controlled rate.

As shown in FIG. 4b, the flat ribbon growth surface (7) passes several treatment stages in the harvesting machine (14) before being rolled up on a take-up reel (21):
In the first treatment stage, the ribbon growth surface (7) is drawn between two rollers (11) which squeeze out the soft inner parts of the tunicates. To avoid dislodging the tunicates from the ribbon growth surface (7) and to assist in pulling it forward, the rollers are typically motor-driven and have surfaces that are spiked or otherwise textured (12). To avoid jamming due to extraneous hard objects such as clams and pebbles that could attach to the growth surface (7), the rollers (11) may be spring loaded or retractable. The soft inner parts of the tunicates are collected by trays (13) and transported away from the harvesting machine (14). Residual material that clings to the rollers (11) is removed by brush rollers (22), collected by the trays (23) and transported away from the harvesting machine (14). Instead of or in addition to the brush rollers (22) other rinsing means may be employed that involve suction, scraping, flushing, etc.
In the second treatment stage, the ribbon growth surface (7) passes a set of knife-edges (16) that scrape off the remaining parts of the tunicates, in particular the tunics, which are collected by trays (17) and transported away from the harvesting machine (14). Any extraneous hard objects such as clams and pebbles that attach to the growth surface (7) may also be scraped off and removed at this stage.
Further treatment stages may be included in the machine (14). In FIG. 4b the ribbon growth surface (7) subsequently passes a cleaning station (18) which in this example is shown to contain brush rollers (19) and high-pressure gas/water jets (20). The cleaning station shall typically incorporate collection means for residual organic material and debris and may include equipment for disinfection, etc.
Finally, the ribbon growth surface (7) is rolled up on a take-up reel (21). Once the entire ribbon growth surface has been pulled out of the water, the direction of travel for the ribbon growth surface is reversed and the ribbon growth surface is returned into the water, ready for a new growth season.

Given the major system components and generic procedures described above, it is possible to identify certain steps in the interactive processes between the tending/harvesting machine (14) and the production modules (10) that are critical in the context of autonomous or highly automated farming operations. They include:

1) Localization and positioning: The tending/harvesting machine (14) is equipped with logic and communication means, and receives details of the task to be performed and the identity (address) of the production module (10) in question. The tending/harvesting machine (14) moves into position above the production module (10), being guided by a system of beacons and sensors or camera-readable tags or geometric cues linked to the production modules (10). Proper feeding of the ribbon-like growth surface (7) into the tending/harvesting machine (14) shall require that the fixtures carrying the growth surface (7) on the production module (10) are aligned parallel to the take-up mechanisms in the machine (14). This may involve rotation or pre-alignment of the production module (10).

2) Coupling and decoupling. The tending and harvesting machine (14) communicates with the production module (10) to prepare for transfer of the growth surface (7) to the machine (14), e.g. by unlocking fixtures on the production module (10). Interaction may occur by purely mechanical means where manipulators are extended from the tending and harvesting machine (14) and/or by activation of motors on the fixtures.

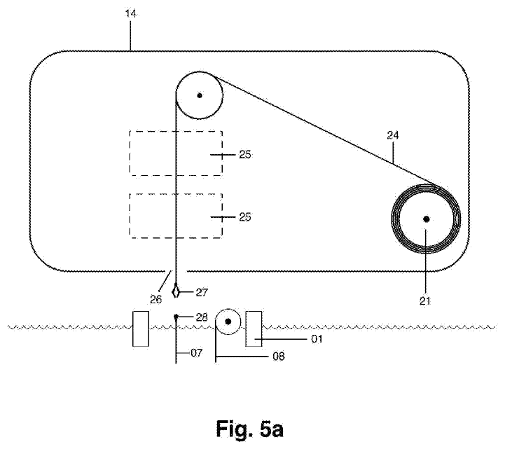

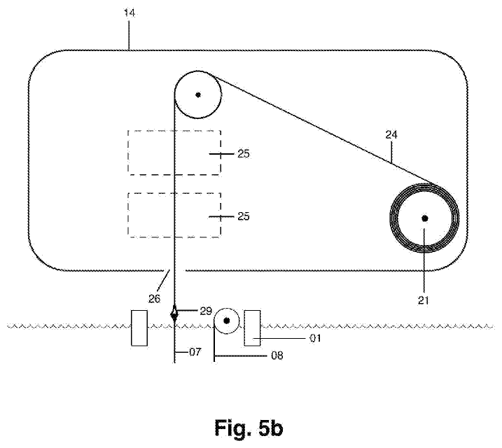

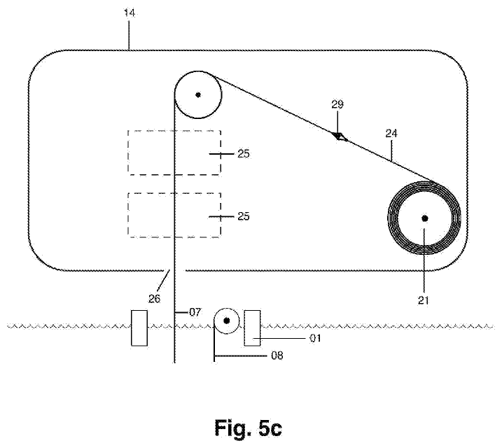

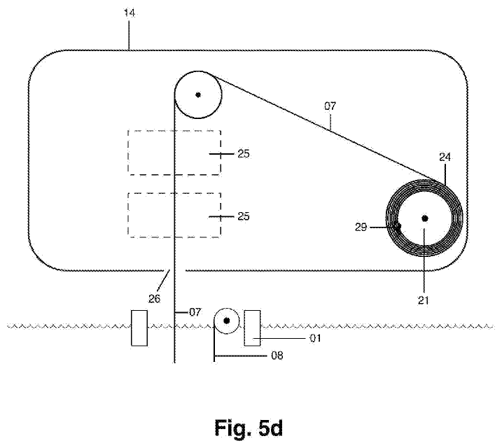

3) Threading of growth surface (7) into the machine. The initial threading of the ribbon growth surface (7) through the various treatment stages in the harvesting machine (14) must be quick and reliable and with no or little required human intervention. One way to achieve this is to employ a permanently pre-threaded dummy ribbon which extends out of the machine (14) and can be coupled end to end with the growth surface (7) as it is released for harvesting from the mounting fixture in the production module (10). This is illustrated in FIGS. 5a-d: A dummy ribbon (24) is pre-threaded through the machine (14), extending from the take-up reel (21) and through the various treatment stages (25) to the opening (26). In FIG. 5a, the dummy ribbon (24) is shown partly extending from the tending/harvesting machine (14), terminated by a coupling device (27) and ready to engage with a mating feature (28) on the growth surface below (7). In FIG. 5b the dummy ribbon (24) is mated end to end with the growth surface (7), and FIGS. 5c,d show how the dummy ribbon is drawn into the tending/harvesting machine (14), pulling the growth surface (7) through the various treatment stages and onto the take-up reel (21). Depending on the bulk and shape of the junction mechanism (29) joining the dummy ribbon and the growth surface (7), the threading process may include automatic retraction of the rollers, brushes and scraping modules during the passage of the junction mechanism through the tending/harvesting machine (14) to avoid hitching and entanglement.

4) Harvesting and cleaning of growth surface in the machine. Ref. descriptions above.

5) Re-deployment of growth surface in production module (10). When the direction of travel of the growth surface ribbon is reversed in order to return it to the water, the rollers, brushes and scraping modules may retract to avoid hitching and entanglement inside the harvesting machine (14).

As shall be evident to a person skilled in the art, the details of specific units in the tending/harvesting machine (14) may differ from those shown in FIGS. 4,5 without departing from the basic functions described above.

Clusters and Macrostructures

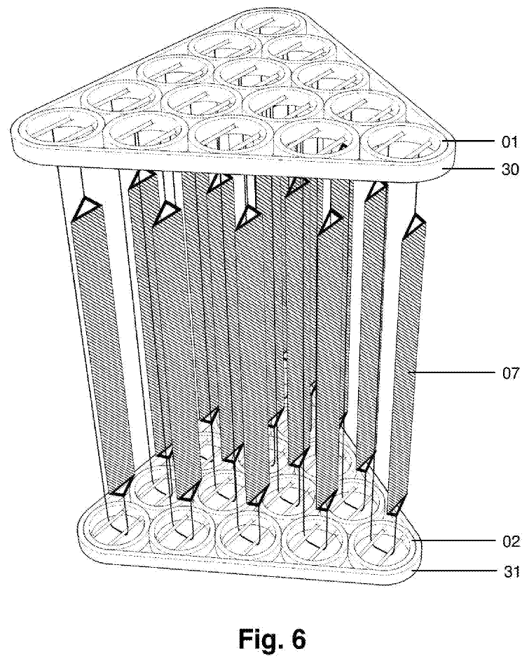

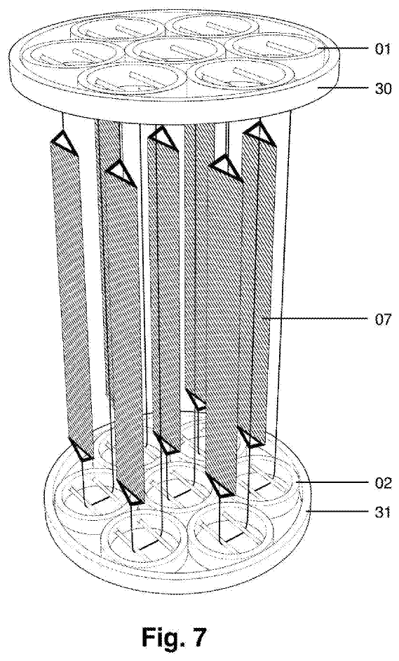

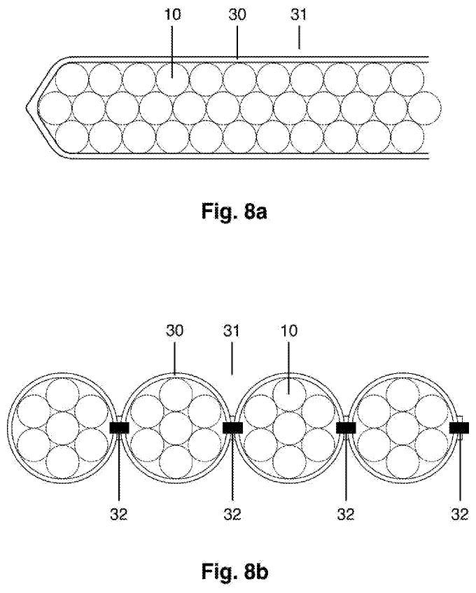

In practical farming facilities, a plurality of production modules (10) are arranged side by side in a preselected geometric pattern, forming a connected entity termed a “cluster” in the following. Depending on how the production modules (10) are assembled and how many are used, clusters may take any shape and size. Examples are shown in FIGS. 6, 7, 8: In FIG. 6, 15 production modules (10) with annular upper and lower parts 81, 2) are arranged in a hexagonal close packed configuration, forming a cluster with a triangular external shape. FIG. 7 shows a linked structure where seven production modules (10) with annular upper and lower parts (1), (2) are arranged in a hexagonal arrangement, surrounded by an upper frame (30) and lower frame (31) giving the cluster a circular external shape. As shall be described in more detail below, clusters with a longitudinal external shape are of particular interest in the present context since they may promote easy access for men and machines that carry out tending and harvesting of the farmed organisms, cf. the examples shown in FIGS. 8 a, b. The longitudinal cluster in FIG. 8a is formed by a plurality of production modules (10) in a close packed hexagonal configuration, surrounded by upper and lower frames (30), (31). The longitudinal cluster structure in FIG. 8b is formed by connecting circular clusters of the type shown in FIG. 7 in a chain by means of stand-off and connecting linkages (32).

The tending/harvesting machine (14) shall require various types of technical infrastructure providing basic functions such as buoyant support and means to move across clusters of production modules (10), as well as positioning and attachment equipment. The harvested material must be transported to recipients and the different stages in the machine (14) need to be supplied with energy and various consumables in liquid and gaseous form. The basic architecture underlying the floating bioproduction facility provides unlimited opportunities for geometric cluster arrangements and a corresponding range of possible solutions to the problem of providing access for the tending and harvesting machine (14). Generally, the latter may be carried by flotation elements integrated into the clusters making up the facility, in which case it may navigate on a floor or rail system supported by the facility. Alternatively, the tending and harvesting machine (14) shall be integrated into a structure that incorporates its own buoyancy and mobility.

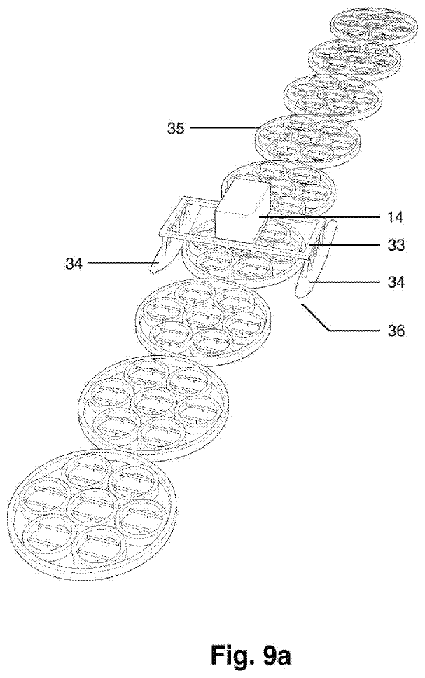

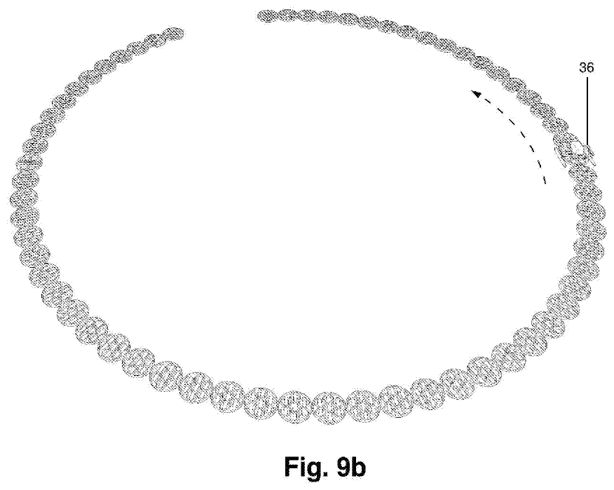

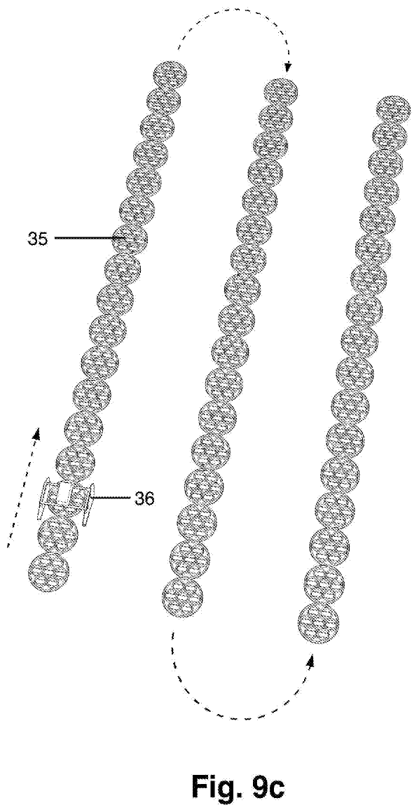

FIGS. 9a,b,c show preferred embodiments of the latter, where a common feature is that each facility is made up of slender chains that can easily be straddled by tending and harvesting infrastructure that is supported on either side of the chain: A tending and harvesting machine (14) of the generic type described in conjunction with FIG. 4 is mounted on a frame (33) which extends across a chain (35) of circular clusters of the type shown in FIG. 8b, being supported by pontoons (34) on either side of the chain. The tending and harvesting machine (14), frame and pontoons constitute an integral unit, termed a harvester (36), which can move along the chain (35) and lock in place at desired locations. When it is desired to position the tending and harvesting machine (14) above a given production module (10), the harvester (36) translates longitudinally along the chain (35) and the tending and harvesting machine (14) traverses laterally on the frame (33), being guided to the desired address by a system that interacts with addressing features on the facility.

1. Tunicate tending and harvesting system for the tending and harvesting of tunicates grown on at least one elongated, suspended growth surface, wherein said system comprises:
a tending and harvesting machine (14), the machine (14) comprising:
at least a first and a second treatment stage, and means for moving the at least one growth surface (7) sequentially through the treatment stages;
the first treatment stage comprising squeezing means (11) arranged to squeeze out soft inner part of the tunicates (15) on the at least one growth surface (7), and first stage collection means (13) arranged to collect the squeezed out parts; and
the second treatment stage comprising removal means (16) for removing parts of the tunicates (15) remaining after the first stage, and second stage collection means (17) arranged to collect the removed parts.

2. Tunicate tending and harvesting system according to claim 1, where the squeezing means comprises two mainly cylindrical rollers (11) arranged to squeeze the tunicates (15) when the growth surface (7) passes there between.

3. Tunicate tending and harvesting system according to claim 1, where the removal means (16) are arranged for scraping off parts of the tunicates (15) remaining after the first stage, and comprises at least one of the following: a scraping edge and brush.

4. Tunicate tending and harvesting system according to claim 1, where the machine (14) further comprises:
a third treatment stage comprising cleaning means (19) for cleaning the growth surface (10) after the second stage, where the cleaning means (19) comprises at least one of the following: a brush roller (19) and a high pressure liquid or gas jet (20).

5. Tunicate tending and harvesting system according to claim 3, where the third treatment stage comprises third stage collection means arranged to collect cleaned off parts of the tunicates (15).

6. Tunicate tending and harvesting system according to claim 4, where the system comprises disinfection equipment arranged to disinfect the growth surface (7).

7. Tunicate tending and harvesting system according to claim 1, where the first treatment stage comprises a residual removal means (22) arranged to remove residuals remaining on the squeezing means (11), and residual collection means (23) arranged to collect the removed residuals.

8. Tunicate tending and harvesting system according to claim 7, where the residual removal means (22) comprises a brush roller.

9. Tunicate tending and harvesting system according to claim 1, where the means for moving the growth surface comprises at least one of the following: a take up reel (21) arranged to collect and feed out the growth surface after/before passing the treatment stages, and squeezing means comprising motorized rollers (16, 22) arranged for contributing to the moving.

10. Tunicate tending and harvesting system according to claim 9, where the system comprises threading means comprising a pre-threaded ribbon (24) extending through the treatment stages to the take up reel (21), arranged to be coupled end-to-end to the growth surface (7), and to pull the growth surface (7) through the treatment stages and onto the take up reel (21).

11. Tunicate tending and harvesting system according to claim 8, where the threading means comprises a re-deployment means arranged to reverse the direction of travel of the growth surface (7) and pre-threaded ribbon.

12. Tunicate tending and harvesting system according to claim 10, where the system comprises means for sensing passage of a junction mechanism joining the growth surface (7) and the pre-threaded ribbon (24) and/or hard objects such as clams and rocks adhering to the growth surface (7) during passage through the tending and harvesting machine (14), and for automatic retraction of at least one of the following: the roller, the brush and the scraping edge in response to signals from the sensing means to avoid hitching and entanglement.

13. Tunicate tending and harvesting system according to claim 1, where the tending and harvesting system further comprises a positioning subsystem arranged for positioning the tending and harvesting machine (14) for connection/access to the at least one elongated, suspended growth surface (7).

14. Tunicate tending and harvesting system according to claim 13, where the positioning subsystem comprises:
a rig arranged for carrying the machine (14);
rig positioning means for positioning the rig in proximity of the at least one growth surface (7); and
machine positioning means arranged for positioning the machine (14) at locations on the rig allowing the machine (14) to access the growth surface (7).

15. Tunicate tending and harvesting system according to claim 13, where the positioning subsystem comprises communication and control means arranged to receive information of a task to be performed related to at least one production module (10) comprising the at least one growth surface (7), and an identity (address) of the at least one production module (10), the rig positioning means adapted to be guided by at least one of the following arranged on the production module (10): beacons, sensors, camera-readable tags, and geometric cues linked to the production modules (10).

16. Tunicate tending and harvesting system according to claim 14, where the rig comprises its own buoyancy means and mobility means for carrying and navigating the machine (14) on water.

17. Tunicate tending and harvesting system according to claim 16, where the buoyancy means comprises at least two pontoons (36) arranged with a distance in between adapted to straddle productions modules where the growth surface (7) is arranged, and where the rig further comprises a frame (33) with an opening allowing access for the machine to the growth surface (7).

18. Tunicate tending and harvesting system according to claim 14, where rig positioning means comprises a floor or rail system arranged on top of a number of production modules (10).

19. Tunicate tending and harvesting method for the tending and harvesting of tunicates (15) grown on at least one elongated suspended growth surface (7), wherein said method comprises:
tending and harvesting the growth surface (7) comprising:
moving the growth surface (7) sequentially through treatment stages;
in a first treatment stage, squeezing out soft inner part of the tunicates (15) on the growth surface (7), and collecting the squeezed out parts; and
in a second stage, removing parts of the tunicates (15) remaining after the first stage, and collecting the removed parts.

20. Tunicate tending and harvesting method according to claim 19, where the step of removing parts comprises scraping with a scraping edge or a brush.

21. Tunicate tending and harvesting method according to claim 20, further comprising the following steps:
in a third treatment stage, cleaning the growth surface (7) after the second stage, where the step of cleaning comprises at least one of the following: brushing by a brush roller (19) and using a high pressure liquid or gas jet (20).

22. Tunicate tending and harvesting method according to claim 19, further comprising:
positioning the tending and the harvesting machine (14);
coupling the machine to the growth surface (7);
threading the growth surface into the machine (14);
tending and harvesting the growth surface (7); and
redeploying the growth surface (7).
